(19) United States
(12) Patent Application Publication
(10) Pub. No.: US 2014/0244637 A1
(43) Pub. Date: Aug. 28, 2014

(54) METHOD AND SYSTEM OF QUERY PROCESSING

(71) Applicant: ChaCha Search, Inc, Carmel, IN (US)

(72) Inventor: Eugene M. O'Donnell, FIshers, IN (US)

(73) Assignee: ChaCha Search, Inc, Carmel, IN (US)

(21) Appl. No.: 14/186,462

(22) Filed: Feb. 21, 2014

Related U.S. Application Data
(60) Provisional application No. 61/767,983, filed on Feb. 22, 2013.

(51) Int. Cl. G06F 17/30

(52) U.S. Cl. CPC G06F 17/30424
USPC 707/736

(57) ABSTRACT

A system and method for responding to a request based on whether the request is seeking factual or subjective information is described. A subjective or objective type is assigned to a request based on automated and or human assisted evaluation. A response algorithm is optimized based on the subjective or objective type assigned to a request.

### BACKGROUND

1. Field of the Invention

The present invention is related to processing of requests and human assisted search.

2. Description of the Related Art

In a system wherein users may submit questions and receive responses the queries may be widely varying. Questions may be presented on any topic, and may require an answer which could be provided by almost any person while other questions may require factual data, research and expertise to respond appropriately.

This issue can be mitigated by allowing responders to search for questions by topic, and to accept or decline to respond to various questions. However this approach may cause comparatively easy questions to receive multiple answers while difficult questions may not receive a response. If queries are directed based on topic, this problem may become more acute as experts may be presented with trivial or redundant questions while novices are presented with difficult questions. In each instance the answerer experience is poor and the participation levels will be low.

One solution to this problem is to provide paid searchers who can respond to user requests. While this greatly reduces latency in responding to questions, and improves overall user experience, it may be costly to have an expert respond to each and every question. Automation may decrease answer cost, but is subject to errors, especially when a query is short, or the query is unclear.

Because of these and other problems a method and system for improved query processing would be greatly appreciated.

### SUMMARY

In order to more efficiently process a query, the nature of the query is important. If a query is seeking factual information it may be more amenable to automation. If automation is not successful and an expert response is required, it is unlikely that more than one answer to the query is available. Thus there is no need for more than one person to respond. Multiple responses may be unwanted and even confusing to the requester. Responses to factual enquiries may be evaluated based on accuracy as there is little ambiguity between a correct and incorrect answer. Crowd sourcing is less likely to produce an accurate evaluation of factual responses. Factual queries may require access to non-public information for which a requester may be willing to pay.

Similarly if a query is subjective or opinion based the query may be amendable to peer-to-peer answering. As the query does not require particular expertise, a first available responder may be suitable for the query. A match between the interests of the responder and the subject matter of the query may be less precise because a responder is not required to be an expert, but merely enthusiastic or interested in the subject matter. Multiple responses to an opinion question may be entertaining to a requester and may generate further interest and engagement between requesters and responders.

A user system is provided whereby a user or requester may submit a question. A user system is provided whereby a user or requester who may also be a responder is able to receive a query and respond to the query. A query is received by a central server. When a query is received a determination is made as to whether the query is seeking objective information or subjective information. The determination that a query is subjective may be done in various ways. In at least one embodiment, an estimate may be applied to content of the query to determine whether it is subjective. Automation techniques may include Bayesian filtering, and natural language processing which may be used to determine whether a query is objective or subjective. In at least one embodiment, a user may indicate whether a query is subjective or objective. In at least one embodiment, a human assistant may be presented with the query. An opinion of the human assistant may be used to determine whether a query is subjective or objective. A user interface used to submit a request may indicate that a request is subjective. A destination, which may be determined by an app used to submit a request may determine whether a request is subjective or objective.

If a query is determined to be objective, the query may be processed using algorithmic evaluations associated with various types of data sources which may respond to factual enquiries. For example, if a query is determined to be factual, a dictionary, weather forecast, database look-up, data feed such as 411, sports information, stock quotes, or other resource may be used to determine whether an automated response is available. If an automated response is not found a user query may be directed to a human assistant. If a human assistant is required, a source of a query may be notified that a human assistant is required. A request requiring a human assistant may require payment based on the human assistant. A human assistant selected to respond to an objective query may be provided with a toolset which is based on the objective nature of the query. A toolset may be specific to a category or subject matter of a query. A toolset may be based on an estimated difficulty of a query.

If a query is determined to be subjective the query may be subjected to automated processing associated with subjective queries. For example, if a query is related to a matter which is amenable to a random response, an automated response based on a pattern match may be provided. Likewise if a query is seeking humorous materials, an automated response which is appropriate to the request may be provided. In at least one embodiment a subjective request may be directed to a number of human responders. Human responders may be users who have elected to respond to queries of other users. Human responders may respond in real time, and/or may respond as determined by the responder. Any number of responses may be provided to a subjective query. Any or all responses may include an advertisement. Selection of a responder may be adjusted when a subjective request is processed. For example a responder associated with a more general subject matter may be notified of a subjective request if a response is desired in real time. A responder associated with a subjective request may be provided with a toolset adapted to responding to subjective requests. For example, a responder may be provided with a limited number of options for responding to a request, or a responder may be provided with selections which cause automated responses to be returned, etc.

Characteristics of a user may be used to determine whether a query is subjective or objective. For example, user history may be used to determine whether a query is subjective or objective. If a user submits a high percentage of queries which are subjective, a subjective process may be assigned by default. Similarly a query may be determined to be subjective based on content of the query and the user. For example, if a user routinely asks for factual information about a topic such as train schedules, postage rates or store hours, queries associated with those topics may be more likely to be determined to be factual or objective. Aggregated characteristics of users may be used to determine whether a query is subjective. For example, if a high percentage of queries associated with a topic, location, noun or category are objective, objective processing may be applied to queries associated with them preferentially.

Additional aspects and/or advantages will be set forth in part in the description which follows and, in part, will be apparent from the description or may be learned by practice of the invention. These together with other aspects and advantages, which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 illustrates a database for requests.

FIG. 3 illustrates a database for users.

FIG. 4 illustrates a database for responders.

FIG. 5 illustrates a database for resources.

FIG. 6 is a flowchart of providing an answer.

FIG. 7 is a flowchart of processing a factual query.

FIG. 8 is a flowchart of processing a subjective query.

FIG. 9 is a Graphical User Interface (GUI) for submitting a query.

FIG. 10 is a GUI for receiving a response.

FIG. 11 is a GUI for classifying a query.

FIG. 12 is a GUI for selecting a query.

FIG. 13 is a GUI for responding to a query.

FIG. 14 is a GUI for finding a response to a query.

FIG. 15 is an alternate GUI for responding to a query.

FIG. 16 is an alternate GUI for receiving a response to a query.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system is provided which includes a user system for submitting a query and receiving a response, a search system receiving the query, a database storing information of queries, search results, searchers, responders, users, resources and/or other information, a responder system receiving a query and providing a response, and a resource system providing answers and/or other media responsive to a request or query or search request or question.

A system is implemented to allow a user to submit a query and receive a response. A response may include any type of media such as text, URL's, audio, video, images, etc. A response may be produced automatically and/or using the assistance of a person. A query may be submitted using any suitable device and/or communication service such as SMS, MMS, voice, Instant Messaging, VoIP, internet packet communication, email, etc.

Processing of a query may be divided into various layers. A determination regarding whether a query is a request for objective or factual information or is a request for subjective or opinion information is made. A query may be determined to be factual in various ways. Automated analysis may be used to determine if a request is seeking factual information. Content of a request may be used to determine whether the query is factual. A user may indicate whether a query is factual. A user may be provided with a control which indicates whether a query is factual. A destination determined based on a user interface may be used to determine whether a request is factual or subjective. A query may be determined to be factual based on actions by a responder or other person to whom a query is presented. A selection of queries may be provided to a user as a form of game wherein a user and/or other person must determine whether a query is seeking fact or opinion.

A layer of processing may consist of automated processing of a query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use. Automated processing of a query which is determined to be factual may be different from automated processing of a query which is determined to be subjective. For example, a match to a subjective query may be less precise than a match to an objective query. Different resources may be used to determine a response to a subjective query than a factual query. A subjective query may entirely skip automation.

A second layer of processing of a query may include a human assistant who analyzes the query or “expediter”. An expediter may use the human ability to recognize context in order to determine a response to a query. An expediter may be provided with relevant context of a query, and offered various options for responding to the query. In its simplest form, an expediter might be presented with a question and two or more options for responding to the question. An expediter may be provided with a rich toolset which provides a greater depth and breadth of responses which may be interactive. In at least one embodiment, an expediter may be provided with responses from a predetermined set of resources. An action of an expediter may be used to determine whether a query is subjective or objective. If a query is determined to be subjective an expediter may not be presented with the query.

A third layer of processing of a query may include a human assistant who responds to the query or “searcher”. A searcher or responder or answerer may receive an interpreted query, information of a source of the query, and be provided with resources for performing a search responsive to a query. A searcher may formulate a response based on an interpreted query, and submit the response for delivery to a user responsive to the query. In at least one embodiment, a searcher may receive information of resources which may be used to provide a response, and/or resources which are excluded from providing a response. Selection of a responder for a subjective query may be different than selection of a responder for an objective query. A more general matching may be applied for selection of a responder for a subjective query. An objective query may be directed to a responder based on a type and level of knowledge required to respond to the query.

A responder or answerer may be provided with alternative responses to a request. An answerer may be presented with resources and/or snippets extracted from resources based on content of a request. An answerer may be presented with materials from a database of previous questions. An answerer may be allowed to indicate a question is too difficult, off topic, or subjective. A question may be indicated as objective or subjective to an answerer. An answerer may be able to sort objective and subjective questions based on various criteria such as keywords, temporal data, difficulty, etc.

A resource may be characterized according to various parameters. A resource may be evaluated based on a number of responses obtained from and/or using the resource. A resource may be evaluated or rated or ranked based on a number of times that a response obtained from the resource is reused. A resource may be evaluated based on an affiliate relationship between a provider of the resource and a provider of search services. A resource may be ranked or evaluated based on a type of response which is to be obtained from the resource. A resource may be ranked based on a category, a topic, a keyword, a level of information provided, a type of information such as objective and/or subjective, etc. Any suitable combination of criteria may be used to evaluate a resource.

As used herein, a “request” means a request for information, products, and/or services. A request or search request or query or question may include various types of media, and may be provided by any user system which may establish communication with a server and/or other devices associated with a search service. A request may be referred to as a “question”, “search request”, “search query”, or “query”.

A “user” is a person who submits a request and may receive any type of information responsive to a request. A user may be any person or entity. A “guide” is a person who assists in processing a request. A guide may be referred to as a “provider”, “searcher”, “human searcher”, “responder”, “answerer”, “expediter”, “transcriber”, “specialist” or “generalist”. Guides may be assigned various roles. A guide may be a user. A guide who transcribes a user request from one form to another may be referred to as a transcriber. A guide who reviews a query, determines a most likely response, and may modify a query may be referred to as an expediter or “ambassador”. A guide who performs a search for queries associated with a specific category may be referred to as a specialist. A guide who performs a search for queries regardless of category may be referred to as a generalist. Any guide may perform any role.

An “advertiser” is any person and/or entity which may provide promotional information or “advertisements” to be delivered to a user. An advertisement may take various forms and/or may include media of any sort which can be delivered to a user device. A “result”, “response”, “answer”, or “search result” is any information which has been determined to be a response to a request. A result may include an advertisement. A result may be any information which is provided as a response to a request. A “resource” or “search resource” may be any source of information which may provide a search result and/or other information. A resource may include a search engine, a web server, a software application, an API, printed media, an RSS feed, streaming media, a web page, a database, etc. A “profile” may be any information associated with a person such as demographic data, geographic data, personality data, affiliations, etc. A result may be an “organic” result which is produced by a search which has no intentional bias applied. A result may be a “sponsored” result which is provided and/or approved by a provider with a commercial interest in the response and/or providing the response to a user based on a request for information associated with the sponsored answer or sponsored result.

A sponsored answer may be created in various ways. A sponsored answer may be created by an advertiser or sponsor based on historical queries received by a search service. For example, an advertiser might search a database for queries including a generic noun which describes a branded product and/or service associated with the advertiser. If an advertiser locates a query of group of queries indicating that generic reference, the advertiser may determine a sponsored answer which is to be associated with a query. A sponsored answer may be a subjective or objective response. An advertiser may be presented with a number of suggested alternate forms of a selected query which may also be associated with a sponsored answer. An advertiser may be presented with usage statistics of a generic and/or a query which may influence a decision by the advertiser. An advertiser may provide targeting information associated with a sponsored answer. Targeting information may include geographic, demographic, personality, affiliation, etc. information which may prioritize and/or limit delivery of a sponsored answer. An advertiser may specify parameters such as pricing, delivery intervals, maximum usages, etc. of a sponsored answer.

A sponsored answer may be created based on a search by a human searcher and/or an automated search. A sponsored answer may be created by a human searcher selected by an advertiser based on a search by the human searcher associated with a generic description such as a keyword. For example, an advertiser may determine that queries associated with the keyword sedan are to be directed to a human searcher selected by the advertiser to perform a search regarding that keyword. A search resource such as a database, web page, software application, etc. selected by an advertiser may be used to procure a sponsored answer by an automated and/or human assisted search. For example, if a query is associated with a category, a search may be performed using a search resource selected for the category by an advertiser to produce a sponsored answer for the query. If a sponsored answer is associated with a search query based on a search, alternate queries may be generated automatically. An advertiser and/or a human assistant may approve and/or reject the association of an alternate query with a sponsored answer. A responder may be provided with sponsored and unsponsored answers and actions of the responder may be used to determine a ranking of the sponsored and unsponsored or “organic” answers.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, an application, regular mail and/or any other suitable type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, and/or any other communication device might be used to establish a communication session.

Communication between a user, a guide, a resource and/or a search system may include conversion of text to speech and speech to text. Any type of media which can be sent and/or received using a communication system may be part of a communication session. A communication session may be conducted using any or all communication services associated with a user, a guide, a resource, and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, a responder, an advertiser and/or a request may be rated. Rating information may be obtained from a user, a guide, an advertiser and/or an administrator of a search system. Rating information may be used to select a user, a guide, a request, a result, a responder, an advertiser, and/or any item based on information associated with an item indicated in a database. A search service may be compensated by advertising revenue. Advertising and/or content may be delivered to a user and/or a guide using any communication service associated with a user and/or a guide. An advertiser may request and obtain information regarding usage, users, demographics, affiliations, etc. associated with queries, keywords, categories, resources etc. and may submit sponsored answers and associate sponsored answers with queries based on information provided.

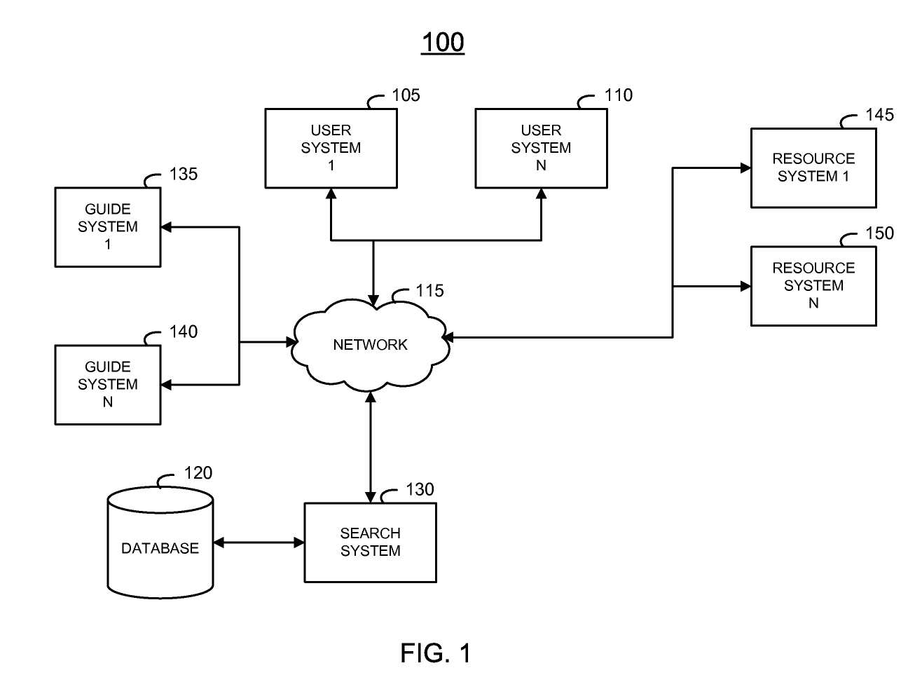

As illustrated in FIG. 1, system 100 includes user systems 105, 110, a network 115 such as the Internet, a search system 130, a database 120, which may comprise various records, guide systems 135, 140, and resource systems 145, 150.

While only a few systems associated with a user, a resource, and a guide or responder are depicted in FIG. 1 it is within the scope of the disclosure for multiple systems for a user, resource, and guide to be utilized. In particular it is envisioned that many user, resource and guide systems may be implemented. The search system 130 may be a composed of many components as described further herein.

Any user system (e.g. the user system 105) can be used, to submit a request to the search system 130 and/or receive a result and/or other information. Any user system may receive and/or provide a response, and/or may provide compensation to the search system 130.

The network 115 may be a global public network of networks (i.e., the Internet) and/or may consist in whole or in part of one or more private networks and communicatively couples the user systems 105, 110, the guide systems 135, 140, and the resource systems 145, 150 with the other components of the system 100 such as the search system 130, and the database 120. The network 115 may include one or more wireless networks which may enable wireless communication between the various elements of the system 100. For example, the search system 130 may receive messages which may be routed via a wireless network controlled by a wireless service to the user systems 105, 110. A wireless service may receive messages from the guide systems 135, 140 via a wireless network which is a part of the network 115, and provide the messages to the search system 130 via an internet connection which is part of the network 115. Similarly a voice communication via wired and/or wireless communication might be established between any elements of the system 100.

The search system 130 allows interaction to occur among the user systems 105, 110, the guide systems 135, 140, and the resource systems 145, 150. For example, a request can be transmitted from the user system 105 to the search system 130, which may provide information obtained from the database 120, which may include an advertisement to the user system 105. Similarly, a search result from an answerer operating the guide system 135 and/or the resource system 145 might be routed to the search system 130, which might process the search result, formulate a response and provide a message to the user system 105. Any type of communication between users, resources and/or guides may be mediated and/or facilitated by the search system 130, and/or other elements of the system 100.

The search system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. The database 120 may utilize any Operating System (OS) such as Linux, WindowsXP®, iOS®, etc. Elements of the database 120 may reside in any suitable elements of the system 100. Any or all elements of the system 100 may include any or the entirety of the database 120.

The user systems 105, 110, the guide systems 135, 140, the resource systems 145, 150 and the search system 130 may include equipment, software, systems and personnel required to send and/or receive messages between a user system 105, 110, the guide systems 135, 140, the resource systems 145, 150 and/or the search system 130 using the network 115. The database 120 includes information which may allow the search system 130 to establish communication between any or all of the elements of the system 100.

A user system, a guide system, a resource system and/or a search system may be a desktop, portable, or tablet PC or Mac®, a mobile phone, a smart phone, a PDA, a server system, a landline phone, a specialized communication terminal, a terminal connected to a mainframe, or any other communication hardware and/or system. The search system 130 may include one or more servers, computers, etc. For example, servers such as the PowerEdge® 2900 by Dell, or the BladeCenterJS22® by IBM, or equivalent systems might be used to implement elements of the search system 130. The search system 130 may utilize an OS such as Microsoft Windows XP®, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems, resource systems and/or to implement the search system 130.

A user may be identified by the search system 130. When a user system, such as the user system 105, establishes a communication session with the search system 130, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 105 and a resource system, a guide system and/or the search system 130. Information such as a keyword, a category, a user profile, a request, a result, etc., may be associated with a user. A user may be required to provide profile information to the search system 130. A user may elect to receive requests from the search system 130. Parameters and/or attributes may be associated with a user and/or a resource as will be further described herein below. Information of a user may be stored in the database 120.

A guide or answerer may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of the guide system 135 in order to communicate with the search system 130. Multiple communication services may be associated with a guide and may allow a communication session to be established between a guide system such as the guide system 135 and a user system, a resource system, a sponsor system, and/or the search system 130. Multiple identifiers of a guide may be associated with each other. Information such as IM credentials, an email address, a phone number, a URL, a username, etc., of a guide may be identified which may allow the search system 130 to establish a communication session between a guide system and a user system, a resource system and/or the search system 130.

When a guide registers with the search system 130 the guide may be associated with one or more keywords, categories, profiles, and/or other information. Information associated with a guide may be stored in the database 120 and may be used for various purposes. Information associated with a guide or responder may be used to rank requests, resources, results, advertisements, sponsors and/or other information which may be presented to the guide. In at least one embodiment, payment information is associated with a guide. In at least one embodiment, a guide may be required to undergo testing to determine whether a guide is able to perform any tasks which may be required by the search system 130. For example, a guide may be assigned to a role such as translator, transcriber, expediter, generalist, specialist, auditor, etc. A guide may be registered by a sponsor. A sponsor may provide compensation to a sponsored guide. A sponsor may designate personnel associated with the sponsor as responders.

A resource system may be registered with the search system 130. At least one communication service may be associated with a resource system. For example, the resource system 145 may be identified by a user, may be selected by a guide, may be approved by an administrator of the search system 130, and/or may be registered by a provider of the resource system 145. A resource may be associated with any items which are reflected in the database 120. A resource may be selected based on items associated with the resource. Any type of communication system may be associated with a resource. A resource may be accessible using an Application Programming Interface (API).

Records may be maintained in the database 120 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein.

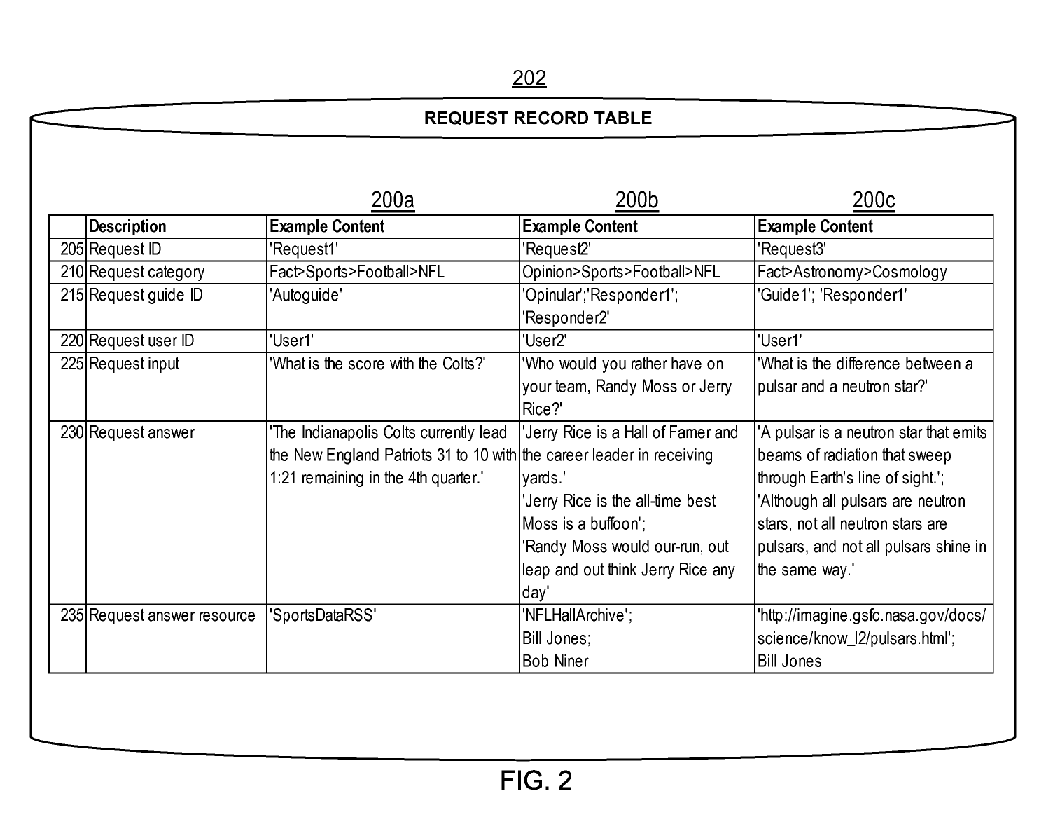

As illustrated in FIG. 2 an exemplary request record table 202 is provided. The request record table may comprise a number of request records of which one or more may be associated with or resident in the database 120 (FIG. 1). The request record table 202 may include information of requests which may be processed. Request records may include a request ID field 205, a request category field 210, a request guide ID field 215, a request user ID field 220, a request input field 225, a request answer field 230, and a request answer resource field 235.

The request ID field 205 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 205. In at least one embodiment, a random number is indicated in the request ID field 205. Using the example in FIG. 2, ‘Request1’ is the request ID associated with the request record 200a.

The request category field 210 may include information of a category associated with a request. Information indicated in the request category field 210 may be used to select an item associated with a request. For example, a category associated with a request may be used to rank responders who may be associated with the type of request. Likewise, a category associated with a request may be used to rank requests which may be presented to a guide. A category associated with a request may be determined based on factors such as keywords of a query, a profile of a user, a selection of a guide, a user history, an action of a user, an action of a responder, etc. A category associated with a system taxonomy may be indicated in the request category field 210. A category may be associated with a request automatically and/or using the assistance of a person. Using the example in FIG. example in FIG. 2, ‘Request2’ may be categorized as ‘Opinion>Sports>Football>NFL’ as indicated in the request record 200b. This may indicate that a person or item associated with the category ‘Opinion>Sports>Football>NFL’ may have a higher ranking for responding to ‘Request2’. A category of a request may be associated with a user submitting the request. Content of a request such as a keyword, named entity, etc. may be used to assign a category or type to a request. A classification as subjective or objective may be required in order that a request may be submitted.

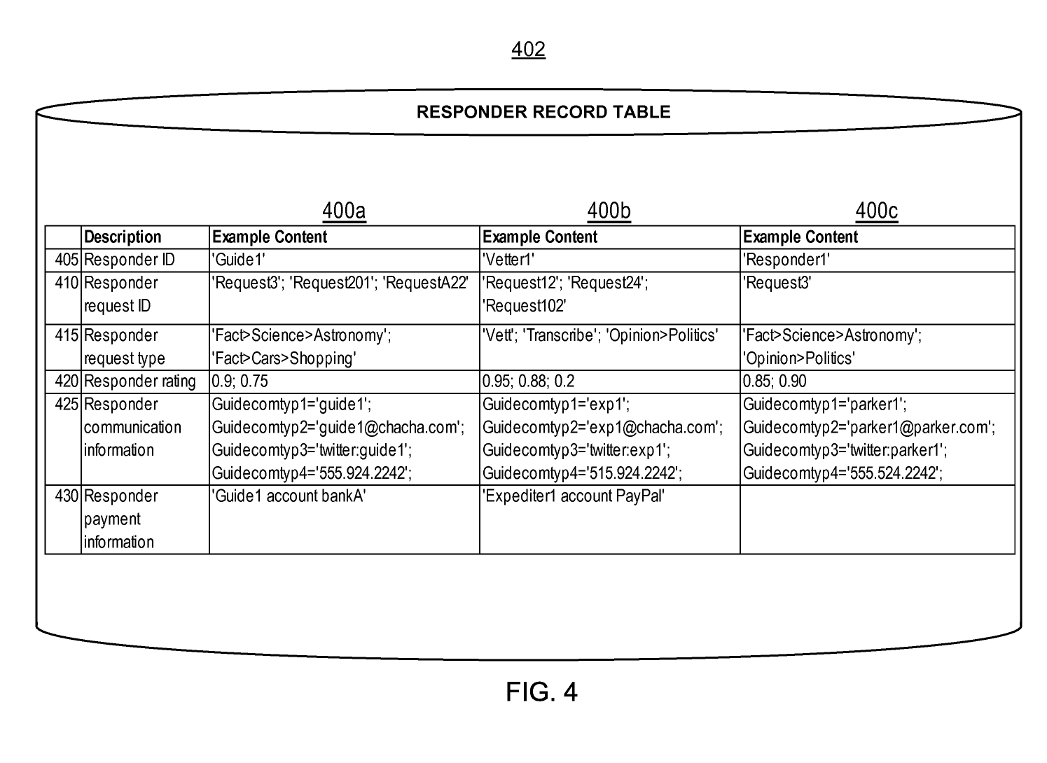

The request guide ID field 215 may include information of a number of guides associated with a request. Content of the request guide ID field 215 may be used to obtain information of a guide using a record such as the records depicted in FIG. 4. If a person is selected for a request, elects to receive a request, provides a response to a request, reviews a result of a request, and/or completes a task associated with a request, an identifier of the person may be indicated in the request guide ID field 215. Using the example in FIG. 2, ‘Opinular’, ‘Responder1’ and ‘Responder2’ are associated with ‘Request2’. This may for example indicate that ‘Request2’ has received an automated response from ‘Opinular’ and a response from ‘Responder1’ and ‘Responder2’.

The request user ID field 220 may include information of a number of users associated with a request. Content of the request user ID field 220 may be used to obtain information of a user associated with a request. For example, if a request is submitted by a user, an identifier of the user may be indicated in the request user ID field 220. A request may not be associated with a user request. For example, the search system 130 (FIG. 1) may provide requests to persons which are not directly related to a user request. The search system 130 may provide a request to a responder based on a selection of the request by a user, a responder, an advertiser, etc. Using the example in FIG. 2, ‘User1’ is associated with ‘Request1’ and ‘Request3’ and ‘User2’ is associated with ‘Request2’. This may indicate that ‘Request1’ and ‘Request3’ were submitted by ‘User1’ while ‘Request2’ was submitted by ‘User2’.

The request input field 225 may include information of a request. Content of the request input field 225 may be provided to a person who accepts a request. Content of the request input field 225 may include any type of information. For example, a pointer to audio, video, text, and/or other media may be indicated in the request input field 225. As illustrated in FIG. 2, the query ‘What is the difference between a pulsar and a neutron star?’ is the request input associated with ‘Request3’, as indicated in the request record 200c. In at least one embodiment, the request input field 225 may indicate an original user request, a categorization, and a rewritten user request.

The request answer field 230 may include information of a response associated with a request. Content of the request answer field 230 may be provided responsive to a request. Content of the request answer field 230 may be stored in the database 120 (FIG. 1). Content of the request answer field 230 may be reviewed and/or rated by a user, a guide, an answerer and/or an administrator. As illustrated in FIG. 2, the responses ‘A pulsar is a neutron star that emits beams of radiation that sweep through Earth's line of sight.’, and ‘Although all pulsars are neutron stars, not all neutron stars are pulsars, and not all pulsars shine in the same way.’ are associated with ‘Request3’ as illustrated in the request record 200c. While a text response to a query is used for the purposes of illustration, any type of media may be indicated in the request answer field 230. In at least one embodiment, a text response and a URL associated with a source of the text response may be indicated in the request answer field 230. In at least one embodiment, a responder may select a response which may cause a URL associated with the response to be inserted in the request answer resource field 235.

The request answer resource field 235 may include information of a resource associated with a request. Content of the request answer resource field 235 may be used for various purposes. A URL associated with a response may be used to determine whether a response is reliable. As illustrated in FIG. 2, a URL associated with an RSS feed is associated with ‘Request1’ which may indicate that a response associated with ‘Request1’ must be treated according to a pre-determined set of rules. An opinion-type response associated with a particular responder may be more likely to be reused based on a rating of the responder. For example, if a user indicates a response of a responder as positive, a future response of the responder which is associated with a category of the response may be more likely to be presented. A response to a subjective request may be obtained from a resource such as the resource ‘NFLHallArchive’ indicated in the request answer resource field 235. If a response is not received from a responder within a predetermined time period of receipt of a request a response extracted from a resource may be provided. Likewise if less than a pre-determined number of responses is returned a response obtained from a resource may be provided. For example, a snippet including a named entity indicated in a user request may be extracted from a resource, which snippet may be provided responsive to a request. Using the example in FIG. 2, the sentence ‘Jerry Rice is a Hall of Famer and the career leader in receiving yards.’ Might be extracted from ‘NFLHallArchive’ based on the presence of the named entity ‘Jerry Rice’. As the query is subjective, the response may be accepted or relevant despite not being a direct answer to the user query.

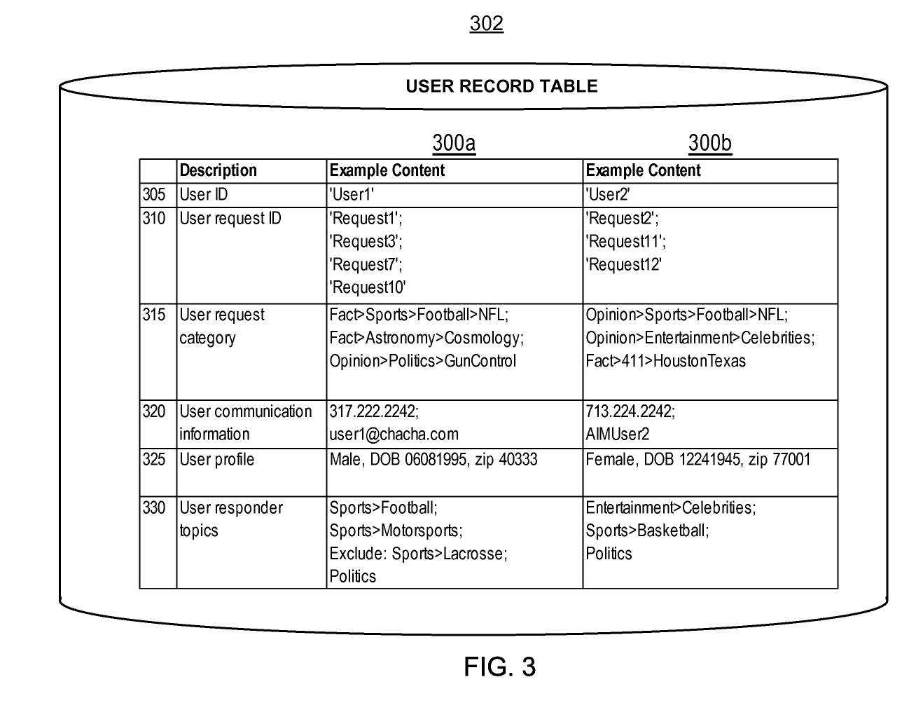

As illustrated in FIG. 3, an exemplary user record table 302 is provided. The user record table 302 may comprise a number of user records of which one or more may be associated with or resident in the database 120 (FIG. 1). The user record table 302 may include information of users. User records may include a user ID field 305, a user request ID field 310, a user request category field 315, a user communication information field 320, a user profile field 325, and a user responder topics field 330.

The user ID field 305 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 305. Using the example in FIG. 3, ‘User1’ is the user ID associated with the user record 300a.

The user request ID field 310 may include information of a number of requests associated with a user. A user request ID may be for example a pointer to a request record associated with a request submitted by a user. If a user submits a request, a request ID may be added to the user request ID field 310. Using the example illustrated in FIG. 3, ‘Request2’, ‘Request11’ and ‘Request12’ are associated with ‘User2’ as indicated in the user record 300b. This may indicate that ‘User2’ has submitted ‘Request2’, ‘Request11’ and ‘Request12’.

The user request category field 315 may include information regarding a category or type associated with a user request. For example, if a request is directed to a type of processing or a category, etc. a type and/or category associated with the processing may be indicated in the user request category field 315. In at least one embodiment, the user request ID field 310 and the user request category field 315 are linked by for example a pointer. In at least one embodiment, a user may be restricted to submitting questions which are subjective or objective type questions. A user may be restricted to accepting requests which are subjective or objective. Content of the user request category field 315 may be used to determine categories of queries which may be directed to a guide, a user and/or a resource. Content of the user request category field 315 may be used to rank resources, guides, advertisements, responders, etc. and may affect a probability that an item will be presented to a user, guide or responder.

The user communication information field 320 may include information of a number of communication services associated with a user. Any information which may be used to establish communication with a user may be indicated in the user communication information field 320. For example, a telephone number, an email address, an IM credential, a URL, a username, a password, and/or other communication information may be indicated in the user communication information field 320. Using the example in FIG. 3, the phone number ‘317.222.2242’ and the email ‘user1@chacha.com’ are associated with ‘User1’.

The user profile field 325 may include information of a profile associated with a user. For example, demographic, geographic, affiliation, personality, and/or other types of anthropic and/or other characteristic information may be associated with a user. A user may provide profile information as part of a registration process. User profile information may be obtained from a database provided by a third party. User profile information may be determined based on test, polling, query history, peer review, and/or other information associated with a user. Using the example illustrated in FIG. 3, ‘Female, DOB 12241945, zip 77001’ are associated with ‘User2’. Profile information may be used to match information provided by a user to other information. For example, a ranking of a guide for a query of a user may be adjusted based on a profile associated with the user. An answer might be modified based on geographic, demographic, etc. profile information of a user. A responder, guide and/or resource might have a different rating and/or ranking based on profile information of a user.

The user responder topics field 330 may include information of topics associated with a user for which the user may be selected as a responder. The user responder topics field 330 may include topics for which a user has elected to receive questions and/or topics for which a user has requested not to receive questions. Content of the user responder topics field 330 may be used to rate a user for a request. As illustrated in FIG. 3, a query associated with ‘Politics’ or ‘Sports’ might be directed to ‘User1’ and ‘User2’, but if the query is associated with ‘Sports>Lacrosse’ ‘User1’ would not receive the query. A user may elect to receive subjective and/or objective requests associated with a category.

As illustrated in FIG. 4 an exemplary responder record table 402 is provided. The responder record table 402 may comprise a number of responder records of which one or more may be associated with or resident in the database 120 (FIG. 1). The responder record table 402 (FIG. 4) may include information of responders. Responder records may include a responder ID field 405, a responder request ID field 410, a responder request type field 415, a responder rating field 420, a responder communication information field 425, and a responder payment information field 430.

The responder ID field 405 includes an identifier of a responder which is preferably unique and is preferably used consistently. A responder ID serves to distinguish a responder record associated with a responder from a responder record associated with other responders. Any number of characters, numbers, and/or other indicators may be used to indicate a responder ID. In at least one embodiment, a random number is indicated in the responder ID field 405. In at least one embodiment, a pseudonym selected by a responder may be indicated in the responder ID field 405. A first and last name of a responder may be indicated in the responder ID field 405. Using the example in FIG. 4, ‘Guide1’ is the responder ID associated with the responder record 400a.

The responder request ID field 410 may include information of a number of requests associated with a responder. Content of the responder request ID field 410 may be used to obtain information of a request. For example, if a user request has been determined to require a number of requests to be performed, the search system 130 (FIG. 1) may assign a unique ID to the requests and may distribute information of the requests to responders. Using the example in FIG. 4, ‘Vetter1’ is associated with ‘Request12’, ‘Request24’ and ‘Request102’ as indicated in the responder record 400b. This may indicate that ‘Vetter1’ has responded to those requests by for example classifying, transcribing, clarifying, answering, etc.

The responder request type field 415 may include information of a number of types of requests which may be processed by a responder. For example, a category and/or keyword associated with a request, a type of request, temporal information associated with a request, etc., which may be used to determine if a responder is to be presented with a request may be indicated in the responder request type field 415. In at least one embodiment, a responder may be assigned to a particular type of request as part of a registration process. A responder may select a type of request which the responder may perform. A responder may be required to pass a test in order to be associated with a type of request. For example if a responder is to provide responses to factual queries, an assessment of a responder's knowledge of a topic may be performed. A responder may be assigned to a role such as vetter, expediter, searcher, etc., which may be indicated in the responder request type field 415. A request indicating a keyword may be directed to a responder based on a keyword. Using the example in FIG. 4, ‘Responder1’ is associated with ‘Fact>Science>Astronomy’ and ‘Opinion>Politics’ as indicated in the responder record 400c. This may for example indicate that ‘Responder1’ may be presented with and/or selected to respond to requests indicating those classifications.

The responder rating field 420 may include information of a number of ratings associated with a responder. For example, quality, speed, peer review, testing results, etc., may be used to determine a rating of a responder. A rating of a responder may be used for purposes such as determining compensation for the responder, selecting a responder to respond to a request, matching a request to a responder, etc. In at least one embodiment, the responder request type field 415 and the responder rating field 420 may be linked by, for example, a pointer. Using the example in FIG. 4, ‘Guide1’ and ‘Responder1’ are associated with the type ‘Fact>Science>Astronomy’ and ‘Vetter1’ and ‘Responder1’ are associated with the type ‘Opinion>Politics’. A response associated with ‘Guide1’ may be more likely to be provided responsive to a request associated with ‘Fact>Science>Astronomy’, while ‘Responder1’ might be more likely to be provided with an opportunity to respond to a request associated with ‘Opinion>Politics’ based on the ratings indicated in the responder rating field 420.

The responder communication information field 425 may include information of a number of communication services associated with a responder. For example, a user name and password, an email address, an IM credential, a phone number, a web page, a physical address, etc., may be indicated in the responder communication information field 425. Using the example illustrated in FIG. 4, ‘Guide1’ is associated with the login ID ‘guide1’, the email ‘guide1@chacha.com’, the Twitter account ‘twitter.guide1’, and the phone number ‘555.924.2242’. This may indicated that ‘Guide1’ may be contacted using the associated communication services.

The responder payment information field 430 may include information of a payment method associated with a responder. For example, banking information, a PayPal® account, a Western Union® account, etc., may be indicated in the responder payment information field 430. Content of the responder payment information field 430 may be used to provide compensation to a responder. For example, payment may be made by Automated Clearing House (ACH), wire transfer, etc., using information indicated in the responder payment information field 430. If a responder is not compensated, the responder payment information field 430 may be blank.

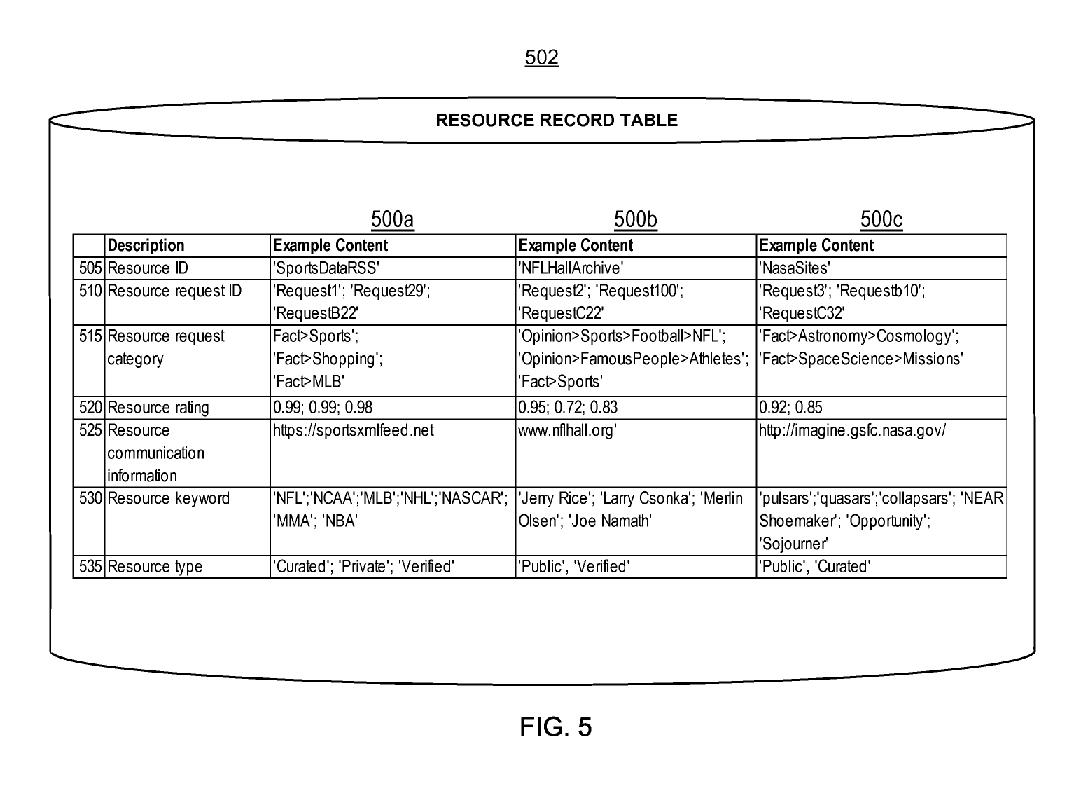

As illustrated in FIG. 5 an exemplary resource record table 502 is provided. The resource record table 502 comprise a number of resource records of which one or more may be associated with or resident in the database 120 (FIG. 1). The resource record table 502 (FIG. 5) may include information of resources. Resource records may include a resource ID field 505, a resource request ID field 510, a resource request category field 515, a resource rating field 520, a resource communication information field 525, a resource keyword field 530, and a resource type field 535.

The resource ID field 505 includes an identifier of a resource which is preferably unique and is preferably used consistently. A resource ID serves to distinguish a resource record associated with a resource from a resource record associated with other resources. Any number of characters, numbers, and/or other indicators may be used to indicate a resource ID. Using the example in FIG. 5, ‘SportsDataRSS’ is the resource ID associated with the resource record 500a. This may indicate that ‘SportsDataRSS’ has been used to produce a search result, and is accessible to a guide, but may not be accessible to a user.

The resource request ID field 510 may include information of a number of requests associated with a resource. Content of the resource request ID field 510 may be used to obtain information of a request. For example, if a resource has been used to respond to a request, an identifier of the request may be indicated in the resource request ID field 510. Using the example in FIG. 5, ‘Request2’, ‘Request100’ and ‘RequestC22’ are associated with the resource ‘NFLHallArchive’ as indicated in the resource record 500b. This may indicate that ‘NFLHallArchive’ has been utilized to respond to ‘Request2’, ‘Request100’ and ‘RequestC22’.

The resource request category field 515 may include information of a number of categories and/or types of requests which may be processed by a resource. For example, a category and/or keyword associated with a request, a type of request, profile, etc., which may be used to determine if a resource and/or a result obtained from a resource is to be presented to a responder and/or a user for a request may be indicated in the resource request category field 515. In at least one embodiment, a resource may be assigned to a category of request as part of a registration process. A resource may be associated with a user, a group of users, an access right, an advertiser or sponsor, etc. A provider of a resource may select a type and/or category of request for which the resource may be used and/or required. A resource may be associated with a category based on a selection by an administrator, based on success rates of obtaining or providing answers, etc. Using the example in FIG. 5, ‘NASASites’ is associated with the category ‘Fact>Astronomy>Cosmology’ and ‘Fact>SpaceScience>Missions’ as indicated by the resource record 500c.

The resource rating field 520 may include information of a number of ratings associated with a resource. For example, a rating of a resource may be based on ratings of answers produced using the resource, a contractual agreement, an affiliation, temporal information such as time spent by guides, etc. A rating of a resource may be used to select a resource which is provided to a searcher, guide, responder, user, etc., to rank a response associated with a resource, etc. In at least one embodiment, the resource request category field 515 and the resource rating field 520 may be linked by, for example, a pointer. Using the example in FIG. 5, ‘SportsDataRSS’ has a rating of ‘0.99’ associated with ‘Fact>Sports’, and ‘NFLHallArchive’ has a rating ‘0.83’, associated with “Fact>Sports’ which may for example indicate that ‘SportsDataRSS’ is more likely to produce an acceptable response for that category. A resource may have a rating corresponding to various categories, types of information, types of tasks, keywords, etc.

The resource communication information field 525 may include information of a number of communication services associated with a resource. For example, a user name and password, an email address, an IM credential, a phone number, a web page, a physical address, etc., may be indicated in the resource communication information field 525. A communication service indicated in the resource communication information field 525 may for example be used to indicate a service by which a resource may be accessed. Using the example illustrated in FIG. 5, the URL <<‘https://sportsxmlfeed.net>> is associated with ‘SportsDataRSS’. This may indicate that a query associated with ‘Fact>Sports’ may be submitted to that URL by for example an API.

The resource keyword field 530 may include information of a number of keywords associated with a resource. A match to a keyword indicated in the resource keyword field 530 may affect a probability that a request will receive a response associated with a resource. For example, a match may prohibit a query from receiving a result from a resource, may increase a ranking of a resource, may be used to associate a category with a request, may identify a resource to be provided to a guide, responder, vetter, etc. In at least one embodiment, keywords included in requests for which a resource has provided an answer may be more highly ranked for a category associated with the query and the resource.

The resource type field 535 may include information of a number of types or characteristics associated with a resource. A type may include an indication of an access right, a commercial arrangement, a preference, quality of content, source of content, etc. A searcher may elect to associate a resource with a type. A system administrator may associate a type with a resource. A provider of a resource may designate a type associated with the resource as part of a registration process. Using the example in FIG. 5, ‘SportsDataRSS’ is a ‘Verified’, ‘Private’, ‘Curated’ resource. This may indicate that content of the resource is controlled, that the resource is not accessible to the general public, and that the content of the resource is verified to be correct.

Although the system and method herein have been described with a limited number of records and specific types of data structures, no limitation is implied thereby. Any equivalent data structures as are well known in the art and any number of fields and/or records may be used to implement the embodiments within the scope of the disclosures herein.

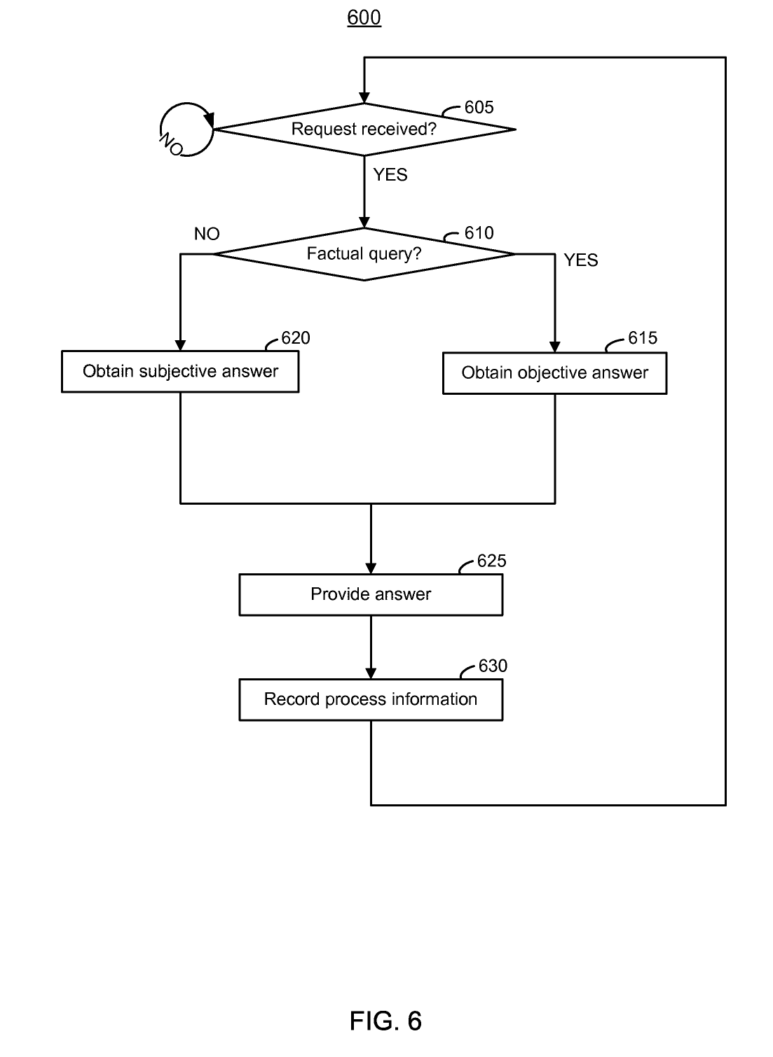

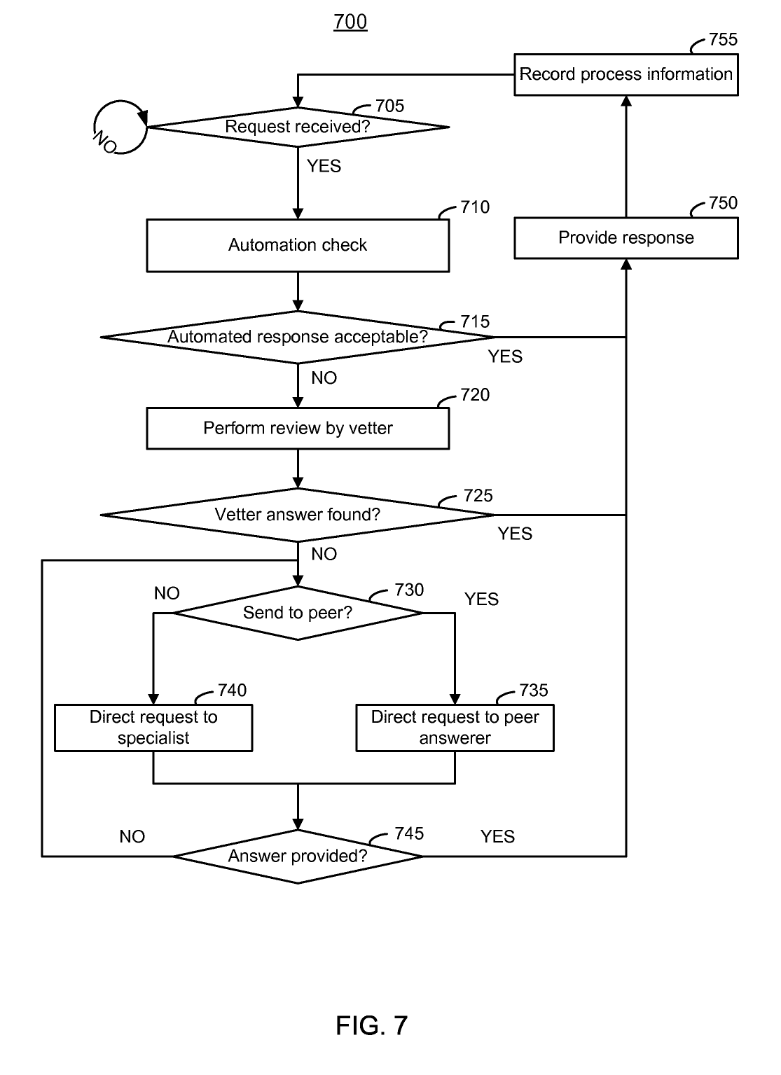

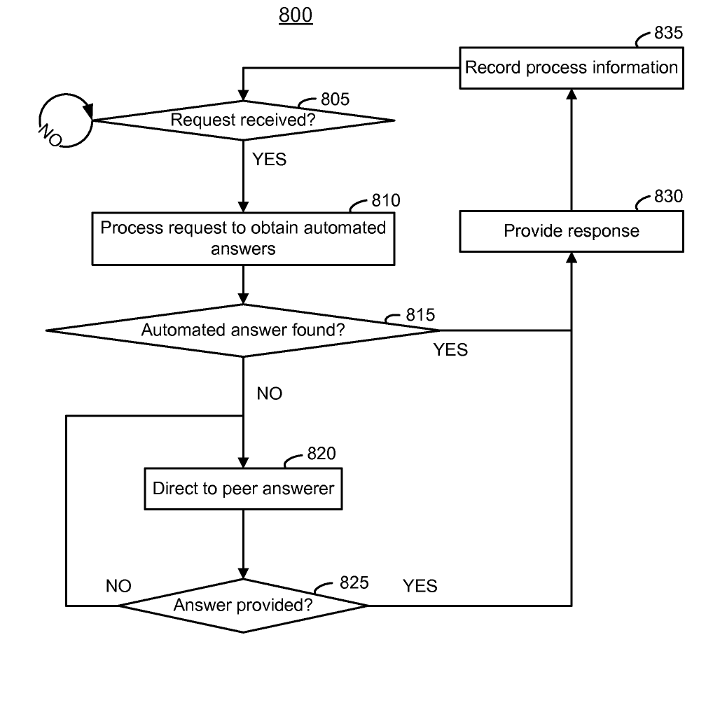

As illustrated in FIG. 6, a process 600 for providing an answer is provided. The process 600 may be performed in whole or in part by any suitable element of the system 100 (FIG. 1). In at least one embodiment, the process 600 is operative on a server associated with the search system 130. A request may be a request for an automated answer, a human assisted answer and/or a combination thereof. The process 600 may comprise a process such as the processes depicted in FIG. 7 and FIG. 8.

In operation 605 (FIG. 6) a determination is made as to whether a request is received. If it is determined in operation 605 that a request is not received, control remains at operation 605 and process 600 continues. If it is determined in operation 605 that a request is received, control is passed to operation 610 and process 600 continues.

The determination in operation 605 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. If a message is received at a server associated with the search system 130, it may be determined that a request is received.

In operation 610 a determination is made as to whether a query is factual. If it is determined in operation 620 that a query is factual, control is passed to operation 615 and process 600 continues. If it is determined in operation 610 that a query is not factual, control is passed to operation 620 and process 600 continues.

The determination in operation 610 may be made based on various criteria. A user selection may indicate that a query is factual. For example, an address at which a request is received may indicate that a query is seeking an opinion. An automated analysis of a request may determine that a request is factual. Comparison to a database of requests may be used to determine whether a request is factual. An action of a person such as a responder may be used to determine whether a query is factual. If a responder is associated with a subjective type answer and declines to answer a request it may be determined that the query is factual. If a subjective response obtained from a resource is rejected by a user and/or a responder, it may be determined that a query is factual. A user interface used to submit a request may determine whether a request is factual and/or subjective. Any suitable criteria may be used to determine that a request is factual.

In operation 615, an objective answer is obtained. Any number of objective answers may be obtained. A single objective answer may be obtained. A process for obtaining an objective answer is further described with respect to FIG. 7. Control is passed to operation 625 and process 600 continues.

In operation 620, a subjective answer is obtained. Any number of subjective answers may be obtained. A plurality of objective answers may be obtained. A process for obtaining a subjective answer is further described with respect to FIG. 8. Control is passed to operation 625 and process 600 continues.

In operation 625, an answer is provided. Any number of answers may be provided. A highest ranking objective answer may be provided. A sponsored objective answer may be provided. A sponsored subjective answer may be provided. A highest ranking subjective answer may be provided. Answers may be presented individually and/or collectively in any sequence. Control is passed to operation 630 and process 600 continues.

In operation 630, process information is recorded. Information of a request, an objective answer, a subjective answer, a category, a keyword, a resource, a user, a sponsor, a guide, a responder, a rating, a ranking, etc. may be recorded. A stored response may be rated, ranked, and/or deleted. Usage and compensation associated with a sponsored answer and/or a guide or responder may be recorded. In at least one embodiment, process information is recorded in the database 120 (FIG. 1). Control is passed to operation 605 and process 600 continues.

As illustrated in FIG. 7, a process 700 for responding to a request is provided. The process 700 may be performed in whole or in part by any suitable element of the system 100 (FIG. 1). In at least one embodiment, the process 700 is operative on a server associated with the search system 130.

In operation 705 (FIG. 7) a determination is made as to whether a factual request is received. If it is determined in operation 705 that a factual request is not received, control remains at operation 705 and process 700 continues. If it is determined in operation 705 that a factual request is received, control is passed to operation 710 and process 700 continues.

The determination in operation 705 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. In at least one embodiment, if a message is received at a server associated with the search system 130, it may be determined that a factual request is received.

In operation 710 an automation check is performed. A query may be compared to a database of stored queries. A request may be submitted to a resource which may produce an automated response. A request may be compared to a template, corpus, etc., which is designed to respond to questions of fact. A number of automated responses may be obtained.

In operation 715 a determination is made as to whether an automated response is acceptable. If it is determined in operation 715 that an automated response is acceptable, control is passed to operation 750 and process 700 continues. If it is determined in operation 715 that an automated response is not acceptable, control is passed to operation 720 and process 700 continues.

The determination in operation 715 may be made in various ways. For example, a query may be compared to a template, a Regular Expression (RegEx) expression, a historical query, etc. in order to determine whether an automated response is acceptable. An automated response may be any response that is produced by sending a query to a system which retrieves information without intervention by a person. For example, a search engine, an RSS feed, a database look-up of a query, a program resident on a computer system and/or other programmatic system for retrieving information may provide an automated response.

In operation 720 a review of a query by a vetter is performed. A vetter may be a responder. A vetter may be presented with results associated with an automation check operation. A vetter may be presented with search results associated with an automation check. A vetter may review results of alternative search queries. Different keywords and/or groups of keywords might be submitted for a search by an automated process and a result of such a search might be presented to a vetter. A vetter may review whether a request is factual.

In operation 725 a determination is made as to whether a vetter answer is found. If it is determined in operation 725 that a vetter answer is found, control is passed to operation 750 and process 700 continues. If it is determined in operation 725 that a vetter answer is not found, control is passed to operation 730 and process 700 continues.

The determination in operation 725 may be made according to various criteria. A vetter answer may be determined to be found based on an action of a vetter. A vetter may select an answer indicated to the vetter. A vetter may decline to select an answer or may indicate that no answer is available. A vetter may indicate that a query is subjective, which may indicate that a vetter answer is found. If a vetter does not select an answer after a predetermined time interval, it may be determined that a vetter answer is not found. Any suitable criteria may be used to determine whether a vetter answer is found.

In operation 730 a determination is made as to whether a query is sent to a peer. If it is determined in operation 730 that a query is sent to a peer, control is passed to operation 735 and process 700 continues. If it is determined in operation 730 that a query is not sent to a peer, control is passed to operation 740 and process 700 continues.

The determination in operation 730 may be made according to various criteria. If a query is associated with a particular user or group of users it may be determined that a query is sent to a peer. If a query has been previously sent to a peer, it may be determined that a query is or is not sent to a peer. If a query is associated with a particular category, keyword, location, profile, etc. it may be determined that a query is sent to a peer or not. A degree of difficulty associated with a query may be used to determine whether a query is sent to a peer. A degree of difficulty may be assigned based on factors such as evaluation by a responder, evaluation by an answerer, a number of answerers registered for a topic, keyword, or category associated with a query, etc. A number of available peer answerers may be used to determine whether a query is sent to a peer. A time period for which a query has been pending may be used to determine whether a query is sent to a peer. A number of peers notified of a query may be used to determine whether query is directed to a peer. A number of requests to which an answerer or a specialist has responded may be used to determine whether a request is directed to a peer answerer. Any suitable criteria may be used to determine whether a query is sent to a peer.

In operation 735 a request is directed to a peer answerer. A peer answerer may be selected according to various criteria. A peer answerer may be notified of a query based on keywords, categories, topics, profiles, affiliations, etc. which are associated with a query and a responder. A peer answerer may be provided with a plurality of queries associated with a topic selected by a responder. A peer answerer may be required to be available in order that a query is routed to the peer answerer. A peer answerer may be required to have previously responded to queries associated with a topic in order that a query is routed to a peer answerer. A peer answerer may be required to demonstrate a level of expertise associated with a topic in order that a request is directed to a peer answerer. Control is passed to operation 745 and process 700 continues.

In operation 740, a request is directed to a specialist. A request may be directed to a specialist selected based on any suitable criteria. A specialist may be a certified expert, may be a person associated with a database which is relevant to content of a request, may be a generalist searcher, may be a business which has elected to provide sponsored answers such as answers to requests associated with a topic, category, keyword, location, profile, etc. Control is passed to operation 745 and process 700 continues.

In operation 745, a determination is made as to whether an answer is provided. If in operation 745 it is determined that an answer is provided, control is passed to operation 750 and process 700 continues. If in operation 745 it is determined that an answer is not provided, control is passed to operation 730 and process 700 continues.

The determination in operation 745 may be made based on various criteria. If a number of answers are received from answerers, it may be determined that an answer is provided. If a query is accepted by an answerer, it may be determined that an answer is provided. If an answer is received from a specialist, it may be determined that an answer is provided. If a peer answerer accepts an answer, it may be determined that an answer is provided. If an answer is not received within a time period, it may be determined that an answer is provided. Any suitable criteria may be used to determine whether an answer is provided.

In operation 750, a response is provided. A response or answer may be provided via any communication service. A factual answer may be provided as an element of the process 600 (FIG. 6). An answer may include any media which may be delivered using a communication service and a device of the user. For example, an SMS message might be delivered to a user mobile device, an Instant Message, an Internet Protocol message, a voice message, etc. may be transmitted. Any number of responses may be provided as any or all of an answer. Control is passed to operation 755 and process 700 continues.

In operation 755, process information is recorded. Information regarding any item such as a user, a guide, a request, a resource, an advertisement, a user, keyword, category, etc. may be recorded and/or updated. For example, a rating may be adjusted, a keyword, category, type, guide, responder, resource, time, user, answer, etc. of a request may be recorded. A rating and/or ranking of a resource may be updated and/or modified. A stored response may be rated, ranked, and/or deleted. In at least one embodiment, process information is recorded in the database 120 (FIG. 1). Control is passed to operation 705 and process 700 continues.

As illustrated in FIG. 8, a process 800 for responding to a subjective request is provided. The process 800 may be used to provide a response to queries which are determined to be subjective. The process 800 may be performed in whole or in part by any suitable element of the system 100 (FIG. 1). In at least one embodiment, the process 800 is operative on a server associated with the search system 130.

In operation 805 (FIG. 8) a determination is made as to whether a request is received. If it is determined in operation 805 that a request is not received, control remains at operation 805 and process 800 continues. If it is determined in operation 805 that a request is received, control is passed to operation 810 and process 800 continues.

The determination in operation 805 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. In at least one embodiment, if a message is received at a server associated with the search system 130, it may be determined that a request is received.

In operation 810 a request is processed to obtain an automated answer. For example, a search of a collection of files may be conducted based on content of a request. If a named entity found in a request is found to match a named entity found in a document a snippet such as a sentence which includes the named entity may be selected as an automated answer. Similarly a query may be compared to a corpus of queries and/or Regular Expressions (RegEx) which is optimized to respond to subjective queries. If a match is found to a request an automated response associated with the match may be selected as an automated response. An automated response to a subjective query may be a programmatic response based on a corpus of responses to previous queries associated with a topic, keyword, etc. An automated response to a subjective request may be based on a historical response to a matching request. Control is passed to operation 815 and process 800 continues.

In operation 815 a determination is made as to whether an automated answer is found. If it is determined in operation 815 that an automated answer is found, control is passed to operation 830 and process 800 continues. If it is determined in operation 815 an automated answer is not found, control is passed to operation 820 and process 800 continues.

The determination in operation 815 may be made based on various criteria. It may be determined both that an automated answer is found and that an automated answer is not found. For example, an automated response may be provided during a time interval when a peer answer is sought. A number of automated answers matching a request may be used to determine whether an automated answer is found. A number of matching responses which were produced by a responder may be used to determine whether an automated answer is found. For example, if no automated answer which is a historical response of a responder is found it may be determined that an automated answer is not found. In an embodiment, it may be determined that an automated response is not found regardless of whether automated responses which are obtained. Any suitable criteria may be used to determine whether a query is a match to a sponsored answer.

In operation 820 a query is directed to a peer answerer. A query may be directed a peer answerer selected based on various criteria. A peer answerer may be selected based on an algorithm optimized for speed. For example, a first available responder associated with a broad class determined by a query may be selected. A responder may be selected based on response frequency. Responders associated with a particular expertise level may be less likely to be selected. A number of responders notified of a request may be adjusted based on whether a request is subjective. A number of responders notified, a specificity of selection, a previous notification, etc. may be used to choose a responder or peer answerer. For example, if a peer answerer responds to a notification of a previous request, a current request may be directed to the peer answerer rather than the previous request. For example, if a previous request associated with a category has received a number of responses, a current request associated with a category may be provided. In an embodiment, a subjective request may not be directed to a paid responder. A peer responder may be a compensated by an advertiser and/or sponsor. Control is passed to operation 825 and process 800 continues.

In operation 825 a determination is made as to whether an answer is provided. If it is determined in operation 825 that an answer is not provided, control is passed to operation 820 and process 800 continues. If it is determined in operation 825 that an answer is provided, control is passed to operation 830 and process 800 continues.

The determination in operation 825 may be made based on various criteria. An action of a peer answerer may be used to determine that an answer is provided. For example a peer answerer may speak an answer, may activate a control in a user interface, etc. Receipt of a number of answers may be used to determine whether an answer is provided. A time period may be used to determine whether an answer is provided. For example, if an answerer does not respond within a given time period, it may be determined that an answer is not provided or that an answer is provided. Any suitable criteria may be used to determine whether an answer is provided.

In operation 830 a response is provided. A response may comprise a peer answer, an automated answer, an indication that an answer is not found, an indication that a query has been incorrectly classified as subjective, etc. A response may include an advertisement selected based on a response, an answerer, a user, etc. Control is passed to operation 835 and process 800 continues.

In operation 835, process information is recorded. Information regarding any item such as a user, a guide, a request, a resource, a responder, a user, keyword, category, etc. may be recorded and/or updated. For example, a rating may be adjusted, a keyword, category, type, guide, responder, resource, time, user, answer, etc. of a request may be recorded. In at least one embodiment, process information is recorded in the database 120 (FIG. 1). Control is passed to operation 805 and process 800 continues.

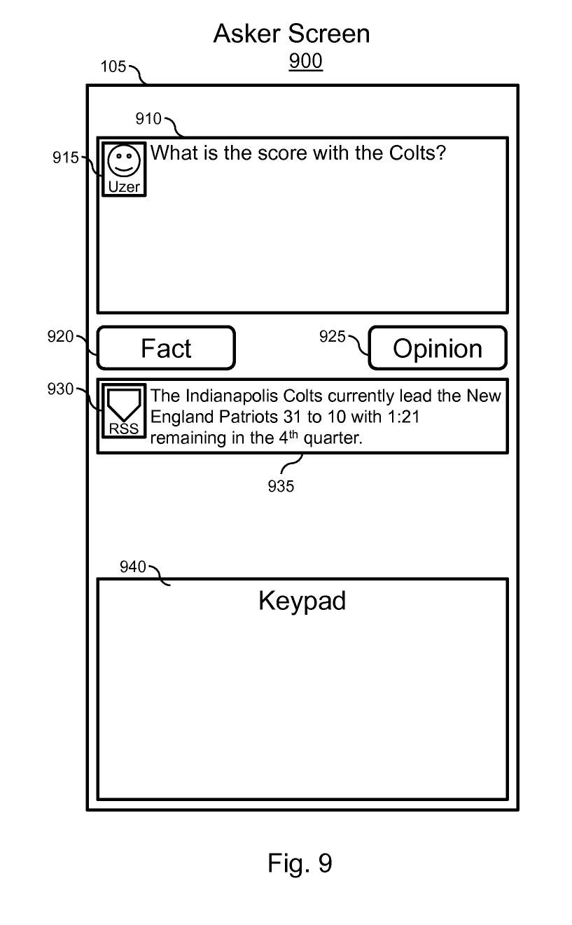

As illustrated in FIG. 9 an exemplary GUI 900 is provided. The query submission GUI 900 may be provided to a user. The GUI 900 may be presented using a system such as the user system 105 (FIG. 1). The GUI 900 may be used to submit any type of request. The GUI 900 may include a query entry area 910, a user identifier 915, a factual query indicator 920, an opinion query indicator 925, a responder indicator 930, a response indicator 935, and a user input control 940.

The request entry area 910 may be used to indicate information of a request. The user indicator 915 may be used to indicate information of a user submitting a request. The factual query indicator 920 may be used to indicate that a request is a request for factual information. The opinion query indicator 925 may be used to indicate that a request is a request for subjective information. The responder indicator 930 may be used to indicate a source of a response. The response indicator 935 may be used to indicate a response associated with a request indicated in the request indicator 910. The user input control 940 may be used to submit a request. While a keypad is used for purposes of illustration, any user input device which is well known in the art may be used to implement the user input control 940.

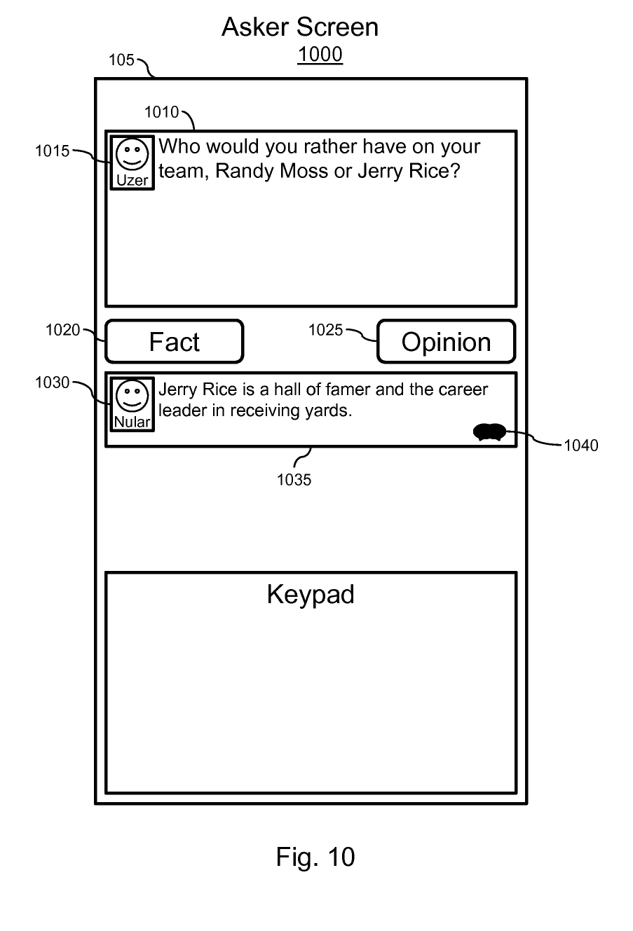

As illustrated in FIG. 10 an exemplary response GUI 1000 is provided. The response GUI 1000 may be provided to a user. The GUI 1000 may be presented using a system such as the user system 105 (FIG. 1). The GUI 1000 may be used to provide a response any type of request. The GUI 1000 may include a query indicator area 1010, a user identifier 1015, a factual query indicator 1020, an opinion query indicator 1025, a responder indicator 1030, a response indicator 1035, and a conversation indicator 1040.

As illustrated in FIG. 10, the query indicator area 1010 may include a subjective query which has been submitted. The user identifier 1015 may indicate a query submitted using the opinion query indicator 1025. The fact indicator 1020 may be active by default, may be active based on content of a query, may be always active, may be suppressed, etc. The responder indicator 1030 may indicate a source of a response. As illustrated in FIG. 10, ‘Nular’ which may be an automated system has responded with an answer indicated in the response indicator 1035. The conversation indicator 1040 may be used to establish a two-way exchange with a responder indicated by the responder indicator 1030. If a responder has declined to receive two-way communications, is an automated system, or for any reason the conversation indicator 1040 may be inactive as indicated by for example the filled indicator in FIG. 10. Any suitable indicator such as color, shading, etc. may be used to indicate that the conversation indicator 1040 is active or inactive.

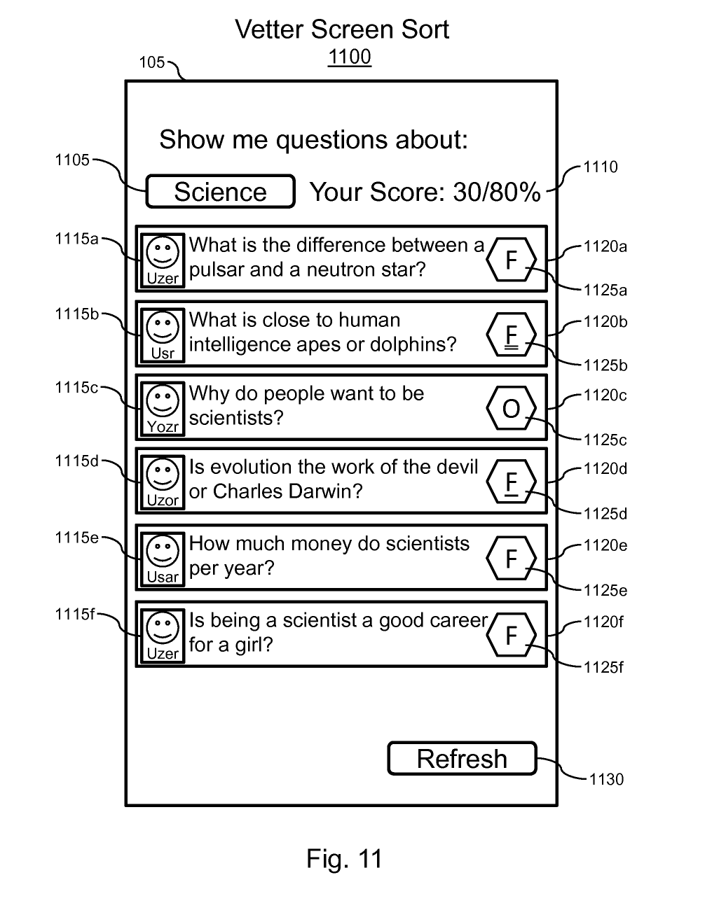

As illustrated in FIG. 11 an exemplary vetter GUI 1100 is provided. The vetter GUI 1100 may be provided to a user, a responder, a guide, etc. The GUI 1100 may be presented using a system such as the user system 105 (FIG. 1). The GUI 1100 may be used to classify a request as factual, subjective, etc. The GUI 1100 may include a category indicator 1105, a score indicator 1110, query indicators 1120a-1120f, user indicators 1115a-1115f, classification indicators 1125a-1125f, and a refresh control 1130.

As illustrated in FIG. 11, the category indicator 1105 may include a category associated with queries presented in the query indicators 1120a-1120f. The category indicator 1105 may be used to select queries associated with a keyword, category, etc. The score indicator 1110 may indicate a total of correct responses, a percentage of correct responses and/or other information which may reflect performance by a person operating the GUI 1100. The user indicators 1115a-1115f may indicate information of a user associated with a request. For example, the user indicator 1115a shows that ‘Uzer’ has submitted the query ‘What is the difference between a pulsar and a neutron star?’ as indicated in the query indicator 1120a. The classification indicator 1125a indicates that the request indicated by the request indicator 1120a has been found to be factual is indicated by the ‘F’. A classification indicator may be changed by a selection. For example, if a request is originally classified as factual, a vetter may indicate that the request is subjective. For example, the classification indicator 1125d may indicate that the query indicated in the query indicator 1120d was originally classified as subjective, but has been changed to be classified as objective as indicated by the underline. Likewise a correct classification may be indicated by a selection. For example if a user agrees with a classification, the user may activate a classification indicator associated with a query. As illustrated in FIG. 11, the classification indicator 1125b may indicate that the user has agreed with the classification of the query ‘What is close to human intelligence apes or dolphins?’ as factual as indicated by the double underline. Any suitable indications such as color, shading, etc. may be used to indicate selection and/or activation of the classification indicators 1125a-1125f. The refresh control 1130 may be used to refresh content of the GUI 1100. For example, activation of the refresh control 1130 may cause selected queries to be scored, may cause new queries to be presented, etc.

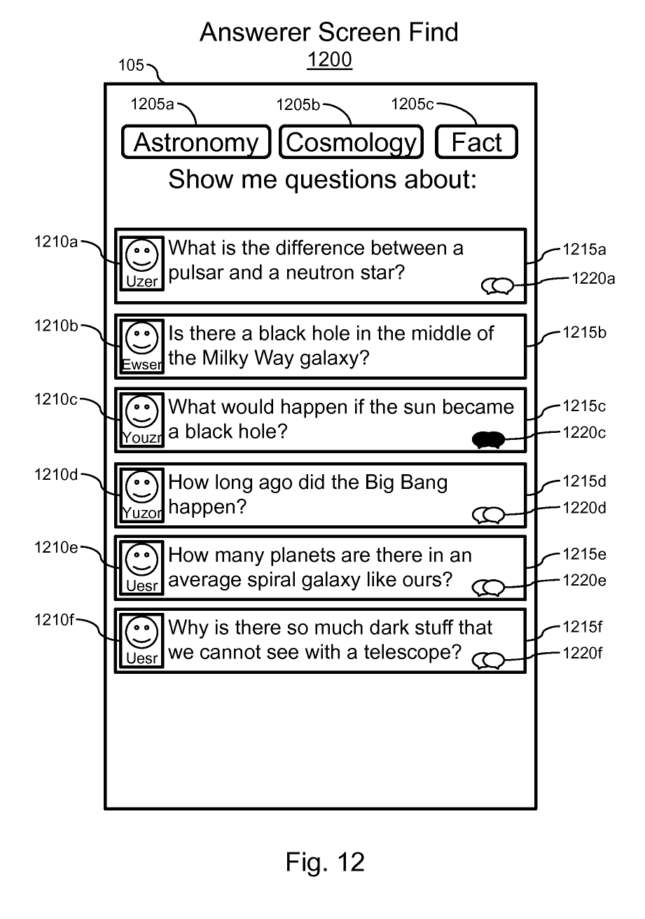

As illustrated in FIG. 12 an exemplary query selection GUI 1200 is provided. The GUI 1200 may be provided to a user, a responder, a guide, etc. The GUI 1200 may be presented using a system such as the user system 105 (FIG. 1). The GUI 1200 may be used to obtain information of a query. The GUI 1200 may include selection indicators 1205a-1205c, query indicators 1215a-1215f, user indicators 1210a-1210f, and conversation indicators 1220a-1220f.

As illustrated in FIG. 12, the category indicators 1205 may include a category, type, etc. which may be used to select a query. The category indicator 1205a may indicate that questions regarding ‘Astronomy’ are desired. The category indicator 1205c may indicate that queries classified as ‘Fact’ are to be provided. The user indicators 1210a-1210f may indicate information of a user associated with a request. For example, the user indicator 1210b shows that ‘Ewser’ has submitted the query ‘Is there a black hole in the middle of the Milky Way galaxy?’ as indicated in the query indicator 1215b. As illustrated in FIG. 12, the conversation indicators 1220a-1220f may indicate that a user associated with a request is available for a two-way communication. For example, the conversation indicator 1220a may indicate that ‘Uzer’ is available for a real-time exchange of information as indicated by the speech bubbles in the conversation indicator 1220a. Any suitable indicator such as color, shading, etc. may be used to indicate status of the conversation indicators 1220a-1220f.

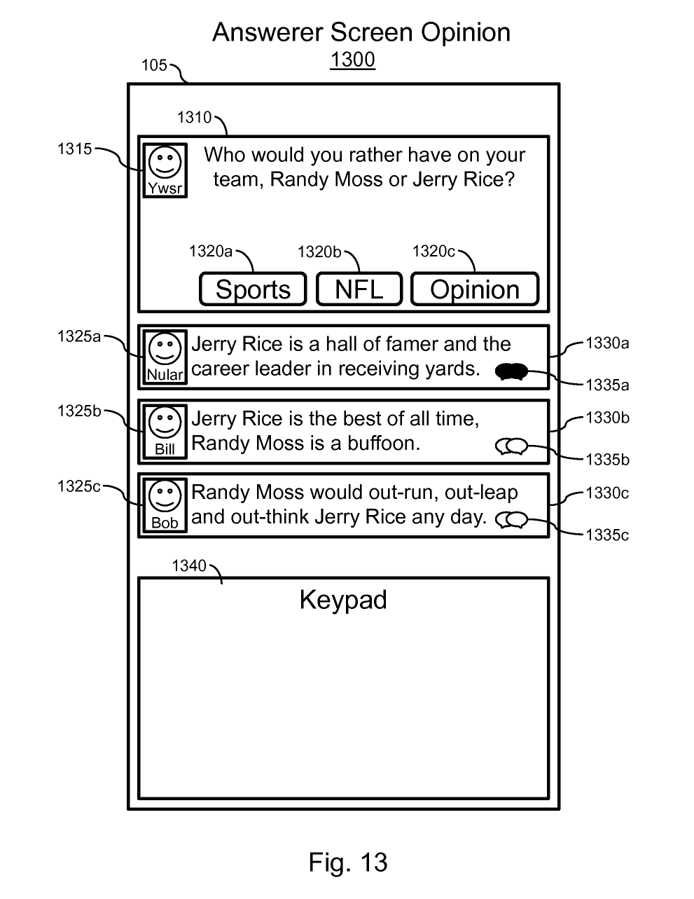

An exemplary GUI 1300 for responding to an opinion type question is illustrated in FIG. 13. The GUI 1300 may be presented on a device such as the user system 105 (FIG. 1). The GUI 1300 may include a query indicator 1310, a user indicator 1315, category indicators 1320a-1320c, responder indicators 1325a-1325c, response indicators 1330a-1330c, responder conversation indicators 1335a-1335c and user controls 1340

The query indicator 1310 may be used to indicate a query to which responses are to be provided. The user indicator 1315 may be used to provide information of a user associated with a request indicated in the query indicator 1310. The category indicators 1320a-1320c may be used to indicate information which may be used to select a query and/or a responder. For example, a category, keyword, topic, classification, etc. associated with a request may be indicated in the category indicators 1320a-1320c. For example, the category indicator 1320c may be used to select ‘Opinion’ type queries. The responder indicators 1325a-1325c may be used to indicate information of a responder associated with a response indicated in the GUI 1300. For example, the responder indicator 1325b may indicate that ‘Bill’ has provided the answer ‘Jerry Rice is the best of all time, Randy Moss is a buffoon.’ The conversation indicators 1335a-1335c may indicate whether a responder is accepting responses. For example, activation of the conversation indicator 1335c might establish a two-way communication with the responder ‘Bob’. A responder might provide a response by activating the query indicator 1310 and providing a response using the user controls 1340.

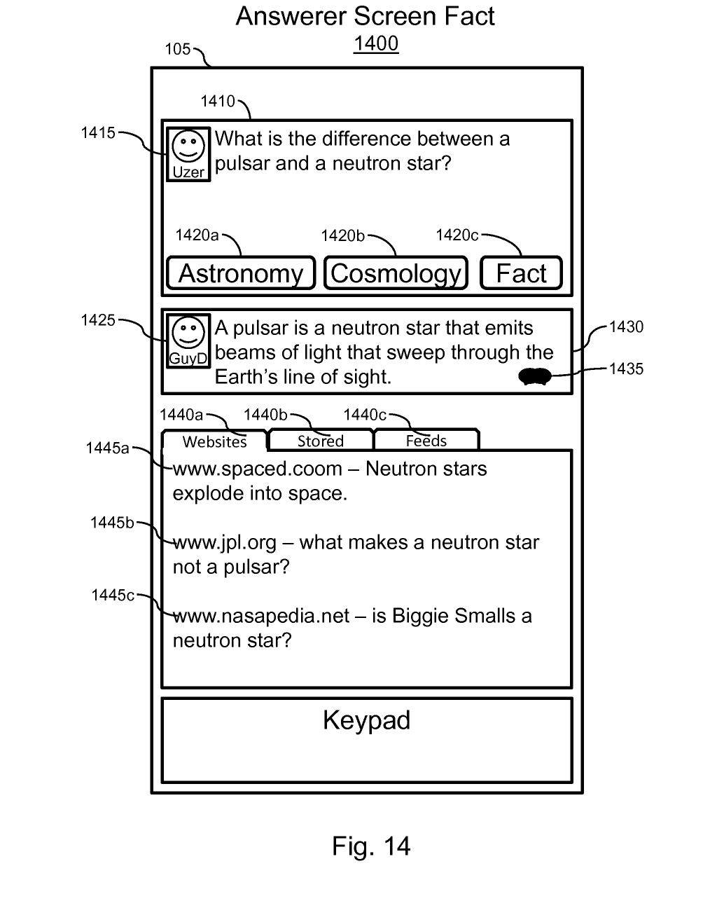

An exemplary GUI 1400 for responding to a factual query is illustrated in FIG. 14. The GUI 1400 may be provided to a responder when a responder elects to respond to a factual request. The GUI 1400 may be provided using a device such as the user system 105 (FIG. 1). The GUI 1400 may include a query indicator 1410, a user indicator 1415, query category indicators 1420a-1420c, a responder indicator 1425, a response indicator 1430, a conversation indicator 1435, response type indicators 1440a-1440c, response indicators 1445a-1445c and user controls 1450.

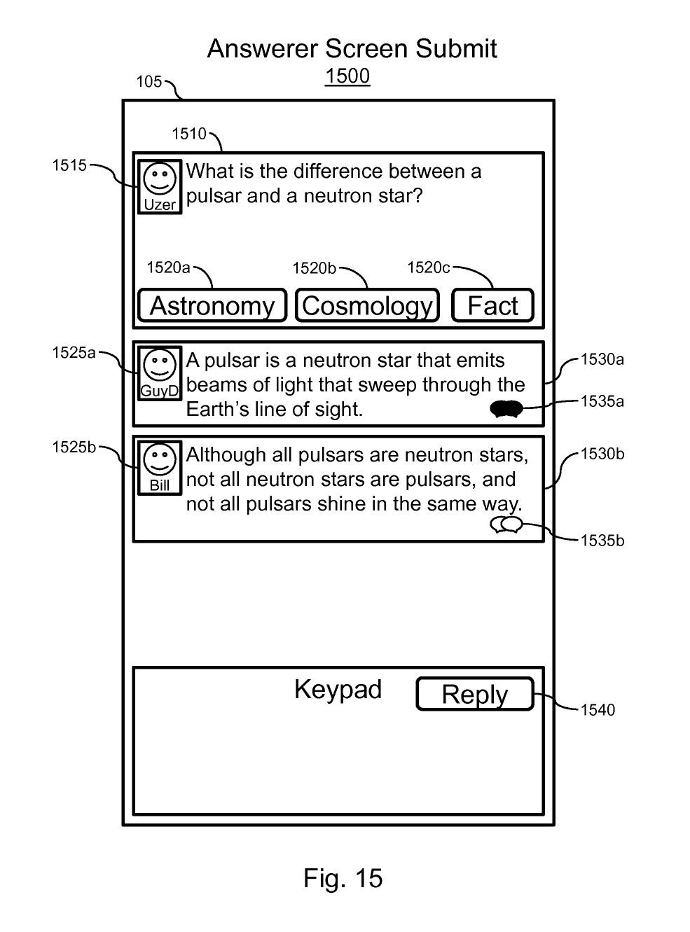

The query indicator 1410 may be used to indicate information of a query to which a responder has chosen to respond. The user indicator 1415 may be used to indicate information of a user associated with a request. The category indicators 1420a-1420c may be used to indicate information associated with a request, which may be used to select requests. The responder indicator 1425 may be used to indicate information of a responder associated with a response indicated in the response indicator 1430. The conversation indicator 1435 may be used to indicate whether a responder indicated in the responder indicator 1425 is accepting messages. Activation of the conversation indicator 1435 may cause a communication session to be established with a responder. The response type indicators 1440a-1440c may be used to indicate a type of response which has been obtained associated with the indicator. For example, the response type indicator 1440a may provide snippets obtained from websites based on any or all elements of a request when activated. The response type indicator 1440b may provide responses associated with stored responses to previous requests which are selected based on any or all elements of a request when activated. The response type indicator 1440c may provide results obtained from RSS feeds, data providers, etc. when activated. The response indicators 1445a-1445c may be used to provide information of responses which may be appropriate. For example, the response indicator 1445b may provide details of a response when activated, and might cause a GUI such as the GUI 1500 illustrated in FIG. 15 to be provided.

An exemplary GUI 1500 for providing a response to a factual request is illustrated in FIG. 15. The GUI 1500 may be presented using a device such as the user device 105 (FIG. 1). If a responder determines that a suitable answer to a request has been obtained, the GUI 1500 may be provided. The GUI 1500 may include a query indicator 1510, a user indicator 1515, category indicators 1520a-1520c, responder indicators 1525a, 1525b, response indicators 1530a, 1530b, conversation indicators 1535a, 1535b, and an action control 1540.

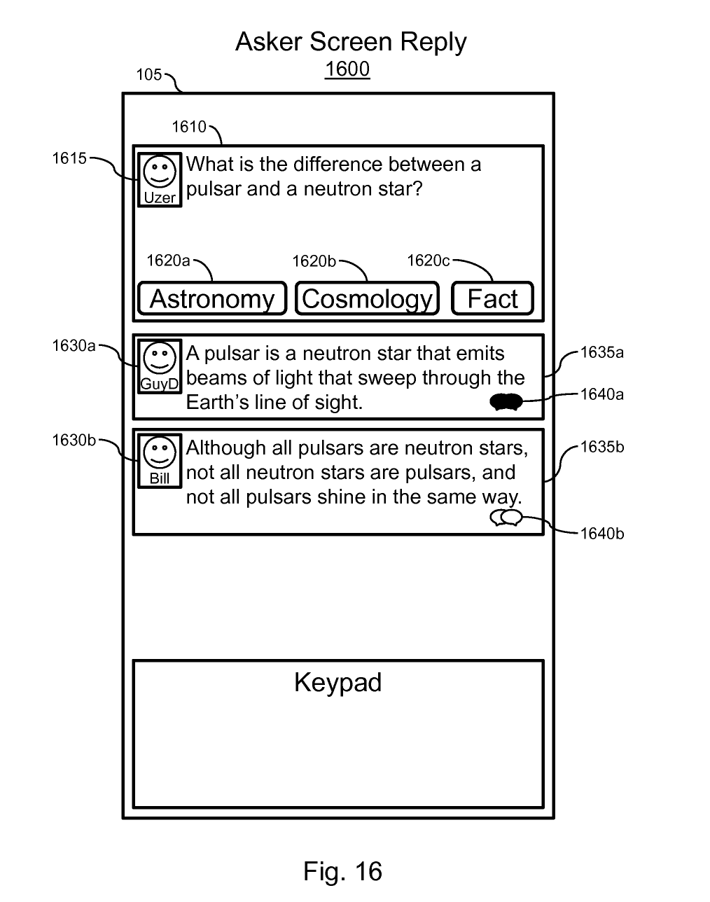

The query indicator 1510 may be used to indicate information of a query to which a responder has chosen to respond. The user indicator 1515 may be used to indicate information of a user associated with a request. The category indicators 1520a-1520c may be used to indicate information associated with a request, which may be used to select requests. The responder indicators 1525a, 1525b may be used to indicate information of a responder associated with a response indicated in the response indicators 1530a, 1530b. The responder indicator 1525b may indicate information of a responder submitting a response using the GUI 1500. The conversation indicators 1535a, 1535b may be used to indicate whether a responder indicated in the responder indicators 1525a, 1525b is accepting messages. A responder may activate or deactivate the conversation indicator 1525b at any time. The conversation indicator 1525b may become inactive after a predetermined time period. The action control 1540 may be used to indicate that a response indicated in the response indicator 1530b is to be provided as a response to the query indicated in the query indicator 1510. Activation of the action control 1540 may cause a GUI such as the GUI 1600 (FIG. 16) to be provided.

An exemplary GUI 1600 for receiving multiple responses to a factual request is illustrated in FIG. 16. The GUI 1600 may be provided when a request is selected by a user. The GUI 1600 may be provided using a device such as the user system 105 (FIG. 1). A user may receive a notification when a new answer is provided to a request. The GUI 1600 may include a query indicator 1610, a user indicator 1615, category indicators 1620a-1620c, responder indicators 1630a, 1630b, response indicators 1635a, 1635b, and conversation indicators 1640a, 1640b. The query indicator 1610 may be used to provide information of a request. The user indicator 1615 may be used to provide information of a user associated with a request. The category indicators 1620a-1620c may be used to provide information of keywords, categories, types, etc. associated with a request, which may be used to select a request, a responder, a resource, etc. The responder indicators 1630a, 1630b may be used to indicate information of a responder associated with a response indicated in the response indicators 1635a, 1635b. The conversation indicators 1640a, 1640b may be used to indicate whether a responder is accepting communications regarding a response. Activation of the conversation indicator 1640b may permit ‘Uzer’ as indicated by the user indicator 1615 to establish a two-way communication with ‘Bill’ as indicated by the responder indicator 1630b.

While the user interfaces described herein have been illustrated using particular types and numbers of interface elements, no limitation is implied thereby, Any number and type of user interface elements as are well known in the art may be used to implement the functionalities described without departing from the scope and spirit of the embodiments described herein. Any or all elements of the user interfaces may be suppressed.

Using the methods and systems described herein processing of a request is optimized based on whether a query is determined to seek objective or subjective information. A request for objective or factual information is evaluated according to criteria which are optimized for a factual response. A responder is selected based on the factual nature of a request. Automated processing of a request is optimized based on whether a request is factual or subjective. Selection of a responder and resources provided to a responder are modified based on whether a request is seeking factual information or opinion. A responder may be presented with various types of user interfaces and information which may be used to determine whether a request is subjective or objective. A number of responses may be increased if a query is subjective. A factual query may be directed to a sole responder.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW. An example of communication media includes a carrier-wave signal. Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method of processing a query comprising:
performing, by a processor, an action responsive to the query when the requests subjective information; and
executing an algorithm when the query requests factual information.

2. The method of claim 1 further comprising:
determining the query seeks subjective information based on a source of the query.

3. The method of claim 2 further comprising:
determining the source of the query based on an address at which the query is received.

4. The method of claim 1 further comprising:
determining the query seeks subjective information based on a choice of a person submitting the query.

5. The method of claim 1 wherein the action comprises delivering information of the query to a person; and
suppressing an automated response to the query.

6. The method of claim 1 wherein the action comprises presenting information of the query to selected users until a pre-determined number of users have been presented with the information of the query.

7. The method of claim 1 wherein the algorithm comprises selecting a responder based on an expertise determined to be relevant to the query.

8. The method of claim 1 wherein the action comprises distributing information of the query to a group of responders; and
choosing the group irrespective of an expertise.

9. The method of claim 8 wherein the algorithm comprises selecting a responder based on the expertise.

10. A system comprising:
a search system device receiving a query, performing an action when the query requests subjective information, and executing an algorithm when the query requests factual information.

11. The system of claim 10 comprising:
a user device submitting the query; and
a responder device receiving information the request and providing a response.

12. A non-transient computer readable storage medium storing therein an instruction for causing a computer to execute an operation, comprising:
performing an action responsive to the query when the requests subjective information; and
executing an algorithm when the query requests factual information.

13. The computer readable storage medium of claim 12 wherein the operation further comprises:
determining that the query requests subjective information until the action indicates to the contrary.

14. The computer readable storage medium of claim 12 wherein the operation further comprises:
determining that the query requests factual information until the algorithm indicates otherwise.

15. The computer readable storage medium of claim 12 wherein the operation further comprises:
executing the algorithm comprising performing a matching of the query to an index, obtaining responses from a search engine based on the query, comparing the query to predetermined patterns associated with an automated resource, and directing results of the matching, obtaining and comparing to a human assistant selected for the request when a response is not acceptable.

16. The computer readable storage medium of claim 15 wherein the operation further comprises:
executing the algorithm comprising providing an answer when the human assistant locates a result, and directing information of the request to a human responder when the human assistant indicates that an answer is not found.

17. The computer readable storage medium of claim 16 wherein the operation further comprises:
executing the algorithm comprising directing information of the request to a group of responders associated with a subject matter of the request and directing the request to person receiving compensation in exchange for a search result when a result is not received from the group.

18. The computer readable storage medium of claim 12 wherein the operation further comprises:
performing the action comprising determining whether a stored response is found, providing the stored response to a source of the query and directing information of the query to members of a group of responders.

19. The computer readable storage medium of claim 12 wherein the operation further comprises:
performing the action comprising determining whether a stored response is found, providing the stored response to a source of the query, directing information of the query to members of a group of responders and excluding a compensated responder from the group.

20. The computer readable storage medium of claim 12 wherein the operation further comprises:
performing the action comprising determining whether a stored response is found, providing the stored response to a source of the query, directing information of the query to members of a group of responders and including a responder in the group based on compensation provided by the responder.
